(19) United States
(12) Patent Application Publication
(10) Pub. No.: US 2010/0325663 A1
(43) Pub. Date: Dec. 23, 2010

(54) BROADCAST RECEIVING APPARATUS AND METHOD FOR SWITCHING CHANNELS THEREOF

(75) Inventor: Won Chang JOE, Yongin-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/820,673

(22) Filed: Jun. 22, 2010

(30) Foreign Application Priority Data
Jun. 22, 2009 (KR) 10-2009-0055447

(51) Int. Cl. H04N 5/44; G06F 13/00; H04N 7/173

(52) U.S. Cl. 725/38; 725/151; 348/731; 348/E05.097

(57) ABSTRACT

A broadcast receiving apparatus and a method for channel switching in a broadcast receiving apparatus are provided. The method includes enabling a decoding unit when a broadcast receiving mode starts, decoding, when a serving transport stream is received via a serving broadcast channel, the received serving transport stream in the decoding unit, terminating the decoding of the received serving transport stream in the decoding unit, when the serving broadcast channel is switched to a target broadcast channel, decoding, when the target transport stream is received via the target broadcast channel, the received target transport stream in the decoding unit, and disabling the decoding unit when the broadcast receiving mode is terminated.

### PRIORITY

This application claims the benefit under 35 U.S.C. §119(a) of a Korean patent application filed on Jun. 22, 2009 in the Korean Intellectual Property Office and assigned Serial No. 10-2009-0055447, the entire disclosure of which is hereby incorporated by reference.

### BACKGROUND OF THE INVENTION

1. Field of the Invention

The present invention relates to communication systems. More particularly, the present invention relates to a broadcast receiving apparatus that can receive a transport stream via a particular broadcast channel and a method for switching channels in the broadcast receiving apparatus.

2. Description of the Related Art

In a contemporary information society, high quality broadcasting services are provided based on digitalization, various channels, and broadband. Recently, as high definition televisions, Portable Multimedia Players (PMPs), portable broadcast devices, and the like have become mainstream items, research has been performed to provide broadcasting services via various modes.

Recent broadcasting services have been provided via digital broadcasting using a broadcast transmitting apparatus. Broadcast transmitting apparatuses process and transmit a Transport Stream (TS) of a plurality of broadcast channels, based on Motion Picture Experts Group 2 (MPEG-2). Therefore, a digital broadcast transmitting apparatus can use a frequency band more efficiently by employing a digital broadcasting method instead of an analog broadcasting method. In addition, a broadcasting receiving apparatus receives the TS of a particular broadcast channel, so that the broadcasting service can be used by broadcast playing apparatuses.

However, the broadcast receiving apparatus according to the related art is disadvantageous in that it requires a great deal of time to perform a channel switching operation. That is, when the broadcast receiving apparatus switches a channel while receiving the TS via a particular broadcast channel and processing the TS, the broadcast receiving apparatus needs to perform an initialization and then receive and process the TS via another broadcast channel. As a result, the broadcast receiving apparatus delays the channel switching operation by an initializing process time period. More particularly, a broadcast playing apparatus may display a black screen or a guide message showing that a channel is being switched. In addition, performance of the broadcast receiving apparatus may deteriorate, thereby inconveniencing users.

Therefore, a need exists for an apparatus and method for reducing the time required for performing a channel switching operation.

### SUMMARY OF THE INVENTION

An aspect of the present invention is to address at least the above-mentioned problems and/or disadvantages and to provide at least the advantages described below. Accordingly, an aspect of the present invention is to provide a broadcast receiving apparatus that can receive a transport stream via a particular broadcast channel.

Another aspect of the present invention is to provide a method for switching channels in the broadcast receiving apparatus.

In accordance with an aspect of the present invention, a broadcast receiving apparatus is provided. The apparatus includes a broadcast buffer for buffering a received transport stream, a decoding unit for decoding the transport stream in the broadcast buffer, and a controller for terminating the decoding of the transport stream by retaining an enabled state of the decoding unit when a channel switching operation is performed.

The controller may move a position of a write pointer in the broadcast buffer when the transport stream is buffered and correct the position of the write pointer when the decoding of the transport stream is terminated.

The controller may move the position of the read pointer to a position to decode the transport stream, and alter the position of the read pointer to be spaced apart from the position of the write pointer, with a preset pointer margin, when the decoding of the transport stream is terminated.

In accordance with another aspect of the present invention, a method for switching channels in a broadcast receiving apparatus is provided. The method includes enabling a decoding unit when a broadcast receiving mode starts, decoding, when a serving transport stream is received via a serving broadcast channel, the received serving transport stream in the decoding unit, terminating the decoding of the received serving transport stream in the decoding unit, when the serving broadcast channel is switched to a target broadcast channel, decoding, when the target transport stream is received via the target broadcast channel, the received target transport stream in the decoding unit, and disabling the decoding unit when the broadcast receiving mode is terminated.

In accordance with still another aspect of the present invention, a method for switching channels in a broadcast receiving apparatus is provided. The method includes buffering, when a serving transport stream is received via a serving broadcast channel, the received serving transport stream in a broadcast buffer, and moving a position of a write pointer along with the buffered serving transport stream, correcting, when the serving broadcast channel is switched to a target broadcast channel, the position of the write pointer in the broadcast buffer, and buffering, when a target transport stream is received via the target broadcast channel, the received target transport stream in the broadcast buffer, based on the corrected position of the writer pointer, and moving the position of the write pointer along with the buffered target transport stream.

The position of the read point may be altered to be spaced apart from the corrected position of the write point, with a preset pointer margin, in the broadcast buffer, and when the received target broadcast transport stream is buffered, the buffered target transport stream may be decoded according to the altered position of the read pointer in the broadcast buffer, and the altered position of the read pointer may be moved.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a configuration of a communication system according to an exemplary embodiment of the present invention;

FIG. 2 is a schematic block diagram illustrating a broadcast receiving apparatus according to an exemplary embodiment of the present invention;

FIG. 3 is a flowchart of a method for switching channels in a broadcast receiving apparatus according to an exemplary embodiment of the present invention;

FIG. 4 is a flowchart of a serving broadcast channel receiving process according to an exemplary embodiment of the present invention;

FIG. 5 is a flowchart of a target broadcast channel receiving process according to an exemplary embodiment of the present invention; and

FIG. 6A to FIG. 6D are views of a method for switching channels in a broadcast receiving apparatus according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and the claims are not limited to the bibliographical meanings, but, are merely used by the inventor to enable a clear and consistent understanding of the invention. Accordingly, it should be apparent to those skilled in the art that the following exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term ‘serving broadcast channel’ denotes a broadcast channel that is currently being used by a broadcast receiving apparatus in a communication system. That is, when a broadcast transmitting apparatus provides broadcasting services via a plurality of broadcast channels, the broadcast receiving apparatus can use a broadcasting service via the serving broadcast channel. The term ‘serving Transport Stream (serving TS)’ denotes a TS that the broadcast transmitting apparatus transmits via the serving broadcast channel, in a communication system. That is, the broadcast receiving apparatus can receive the serving TS via the serving broadcast channel.

The term ‘target broadcast channel’ denotes a broadcast channel to which the broadcast receiving apparatus makes an attempt to connect by switching channels, in a communication system. That is, the broadcast receiving apparatus disconnects from the serving broadcast channel by switching channels and connects to the target broadcast channel to use a broadcasting service. The term ‘target Transport Stream (target TS)’ denotes a TS that the broadcast transmitting apparatus transmits via the target broadcast channel, in a communication system. That is, the broadcast receiving apparatus can receive the target TS via the target broadcast channel.

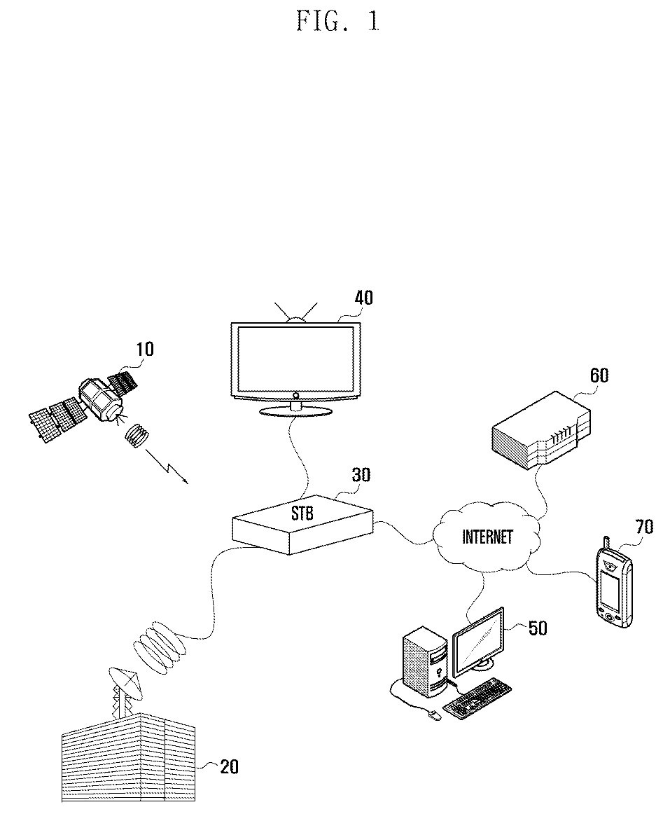

FIG. 1 illustrates a configuration of a communication system according to an exemplary embodiment of the present invention.

Referring to FIG. 1, the communication system includes a broadcast transmitting apparatus 10 or 20, a broadcast receiving apparatus 30, and a broadcast playing apparatus 40, 50, 60 or 70. The broadcast receiving apparatus 30 and the broadcast playing apparatus 40, 50, 60 or 70 may be integrally formed. That is, when the communication system receives satellite or terrestrial broadcast signals via a satellite 10 or a broadcast station 20, the broadcast receiving apparatus 30 processes the received broadcast signals and transmits a processed TS. The broadcast receiving apparatus 30 may be a set-top-box. The broadcast receiving apparatus 30 may wirelessly or wiredly receive the broadcast signals. Alternatively, the TS may be transmitted over the Internet. When the TS is received, it can be played back by a digital TV 40, a Personal Computer (PC) 50, a Video on Demand (VoD) server 60, or a mobile communication terminal 70.

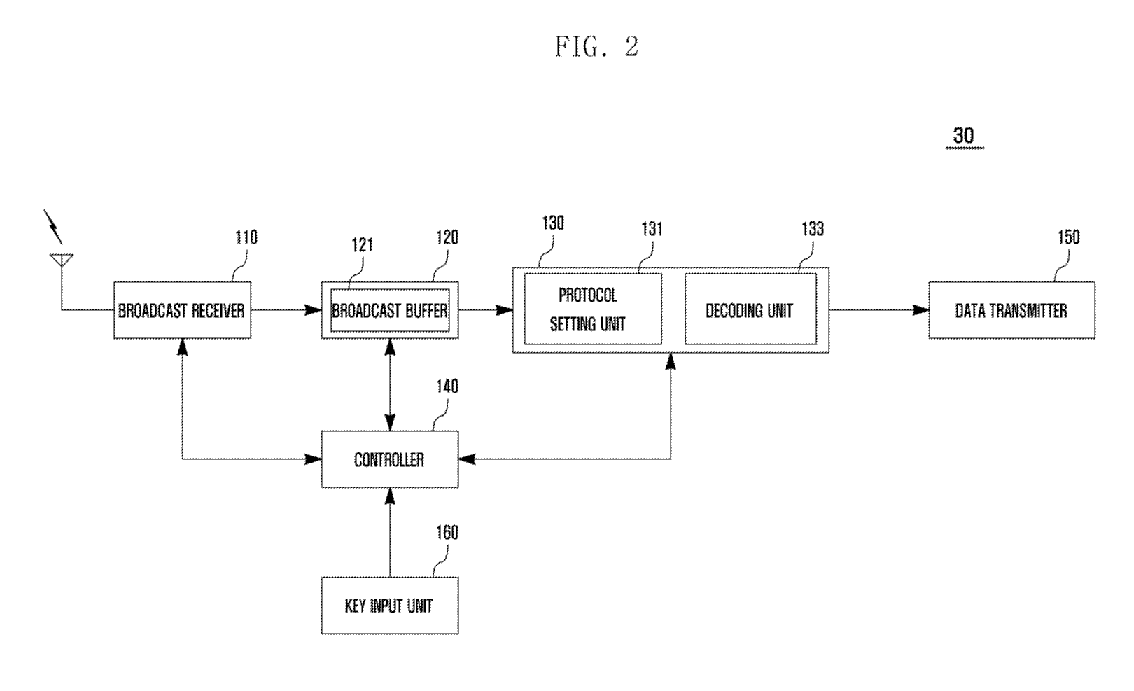

FIG. 2 is a schematic block diagram illustrating a broadcast receiving apparatus according to an exemplary embodiment of the present invention.

Referring to FIG. 2, the broadcast receiving apparatus 30 includes a broadcast receiver 110, a memory 120, a decoder 130, a controller 140, a data transmitter 150, and a key input unit 160.

The broadcast receiver 110 receives broadcasts. The broadcast receiver 110 determines a physical channel frequency of a particular broadcast channel. The broadcast receiver 110 processes broadcast signals received via the particular physical channel frequency and outputs a TS. To this end, the broadcast receiver 110 includes at least one tuner and a demodulator.

The memory 120 is comprised of a program memory and a data memory. The program memory stores programs for controlling operations of the broadcast receiver 30. In an exemplary implementation, the program memory stores a program for switching channels. The data memory stores data generated while the programs are executed. The memory 120 further includes a broadcast buffer 121 that buffers the TS of the particular broadcast channel.

The decoder 130 decodes the TS and outputs video data, audio data, additional broadcast information, and the like. The decoder 130 may individually decode video data and audio data according to data protocol of a corresponding broadcast channel, i.e., video protocol and audio protocol.

The decoder 130 includes a protocol setting unit 131 and a decoding unit 133. The protocol setting unit 131 detects and sets the data protocol of a corresponding broadcast channel. The decoding unit 133 decodes the TS based on the data protocol. The decoding unit 133 verifies the data protocol via the protocol setting unit 131 and determines a decoding processing method. The decoding unit 133 decodes the TS of the broadcast buffer 121 according to a determined broadcast processing method.

The controller 140 controls the operations of the broadcast receiving apparatus 30. The controller 140 controls input and output positions of the TS in the broadcast buffer 121. The controller 140 controls a current input position of the TS in the broadcast buffer 121, via a write pointer, and a current output position via a read pointer.

The controller 140 switches channels in a broadcast receiving mode. The controller 140 allows the decoding unit 133 to retain its enabling state, irrespective of the channel switching operation in the broadcast receiving mode. That is, when the controller 140 begins operating in a broadcast receiving mode, the controller 140 initializes the broadcast buffer 121. The controller 140 enables the decoding unit 133. When performing a channel switching operation, the controller 140 switches a current channel to a broadcast channel via which the TS is received. While retaining the enabled state of the decoding unit 133, the controller 149 terminates the decoding process. The controller 140 may retain an enabled state of the protocol setting unit 131 and also initialize the protocol setting unit 131. Furthermore, when the controller 140 terminates the broadcast receiving mode, the controller 140 disables the decoding unit 133.

The data transmitter 150 transmits the TS, for example, audio data and video data, from the decoder 130.

The key input unit 160 includes a plurality of keys for receiving numerical and alphabetical information and setting a variety of functions. The key input unit 160 may be implemented with a remote commander. In an exemplary implementation, the key input unit 160 includes keys for switching channels.

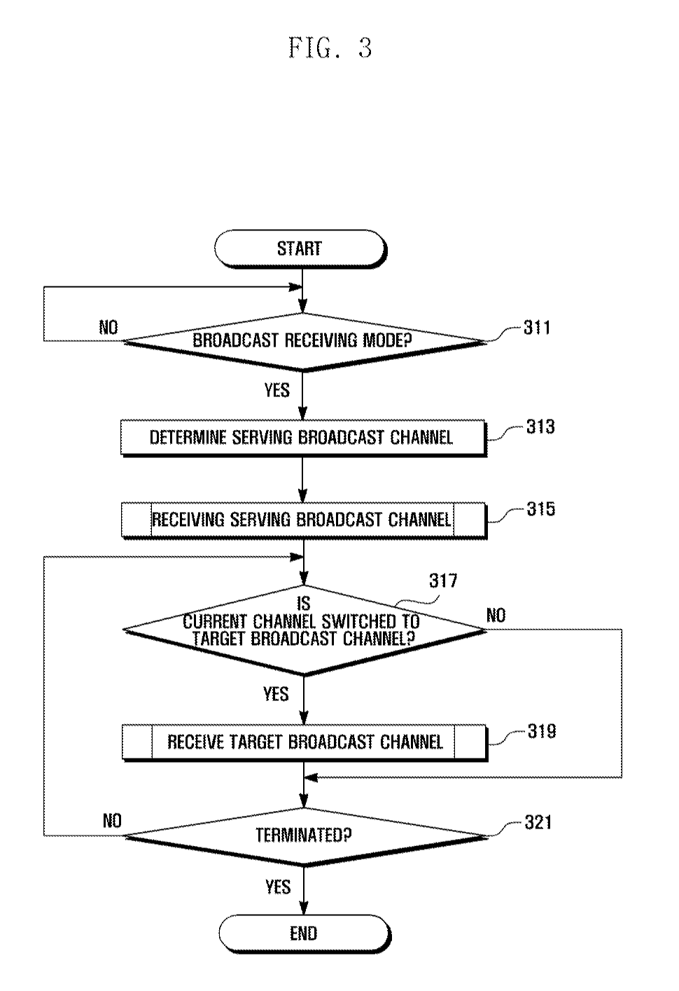

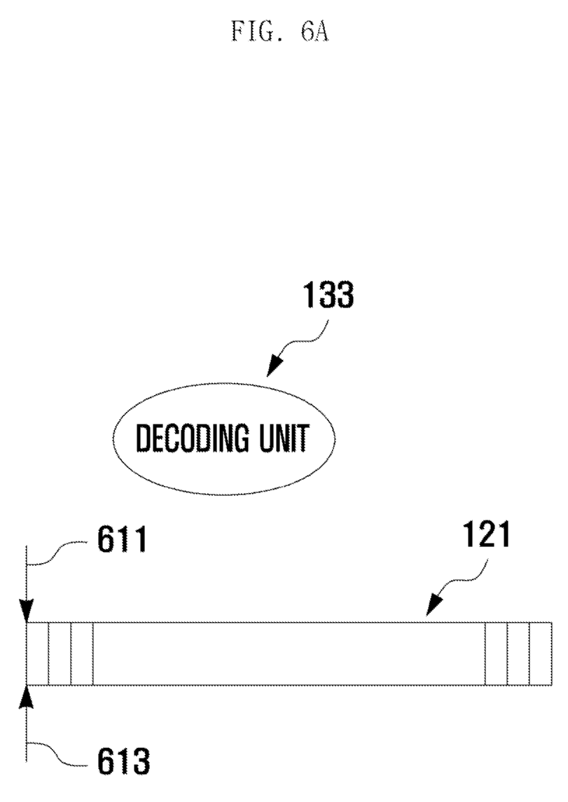

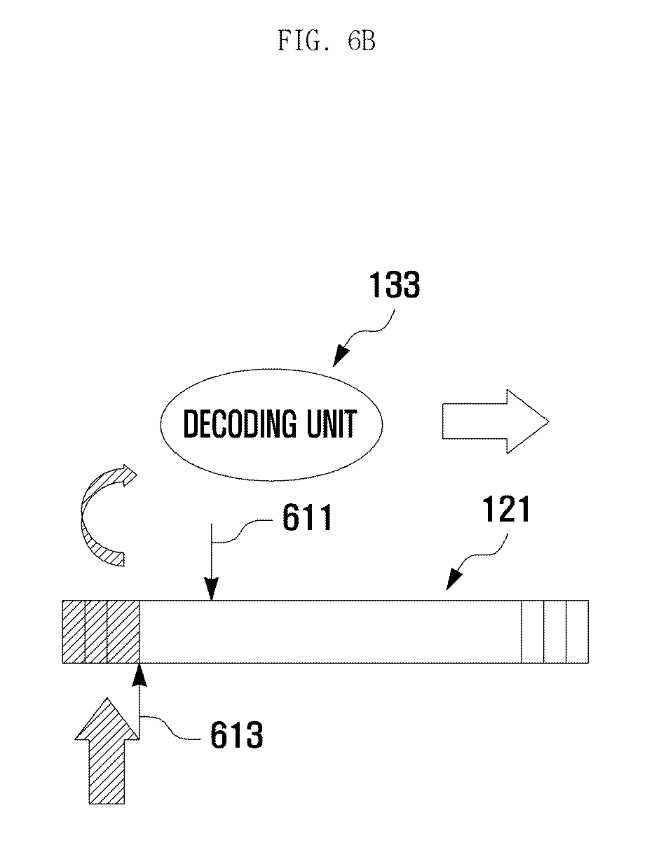

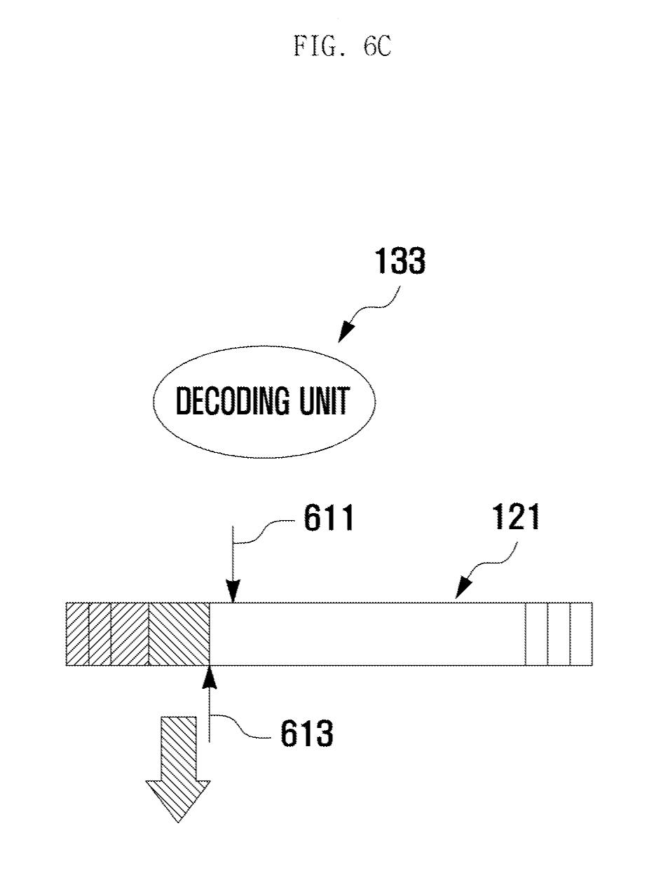

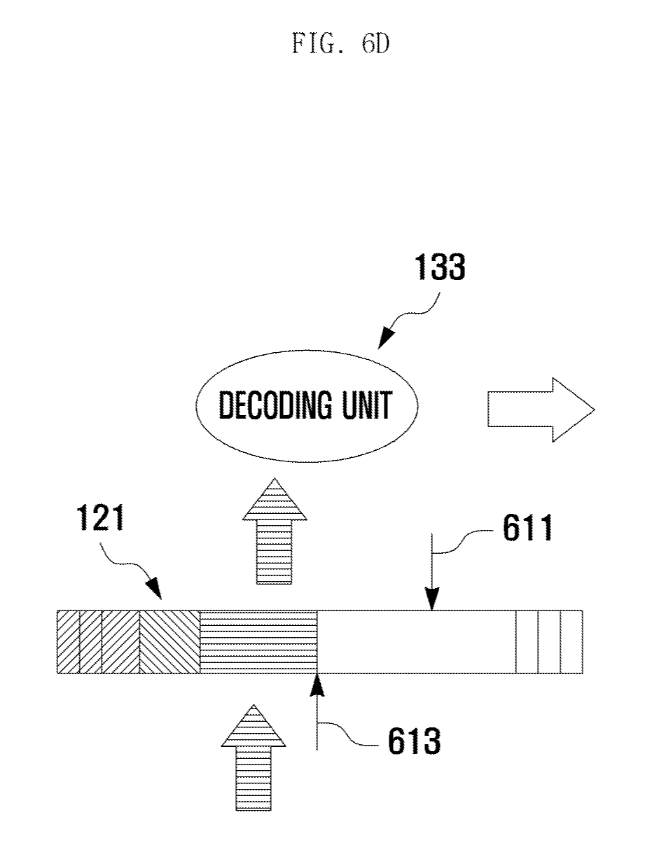

A method for switching channels in a broadcast receiving apparatus, according to an exemplary embodiment of the present invention, is described in more detail below with reference to FIG. 3, and FIGS. 6A to 6D.

FIG. 3 is a flowchart of a method for switching channels in a broadcast receiving apparatus, according to an exemplary embodiment of the present invention.

FIG. 6A to FIG. 6D are views of a method for switching channels in a broadcast receiving apparatus according to an exemplary embodiment of the present invention.

Referring to FIG. 3, the controller 140 is operated in a broadcast receiving mode in step 311. During the broadcast receiving mode, the controller 140 enables the protocol setting unit 131 and the decoding unit 133. Thereafter, the controller 140 determines a serving broadcast channel in step 313. The controller 140 may select a broadcast channel as a serving broadcast channel according to an arbitrary method or a signal input via a key input unit 160. The controller 140 uses a broadcasting service via the serving broadcast channel in step 315, as illustrated in FIGS. 6A and 6B. During this process, the controller 140 retains an enabled state of the protocol setting unit 131 and the decoding unit 133.

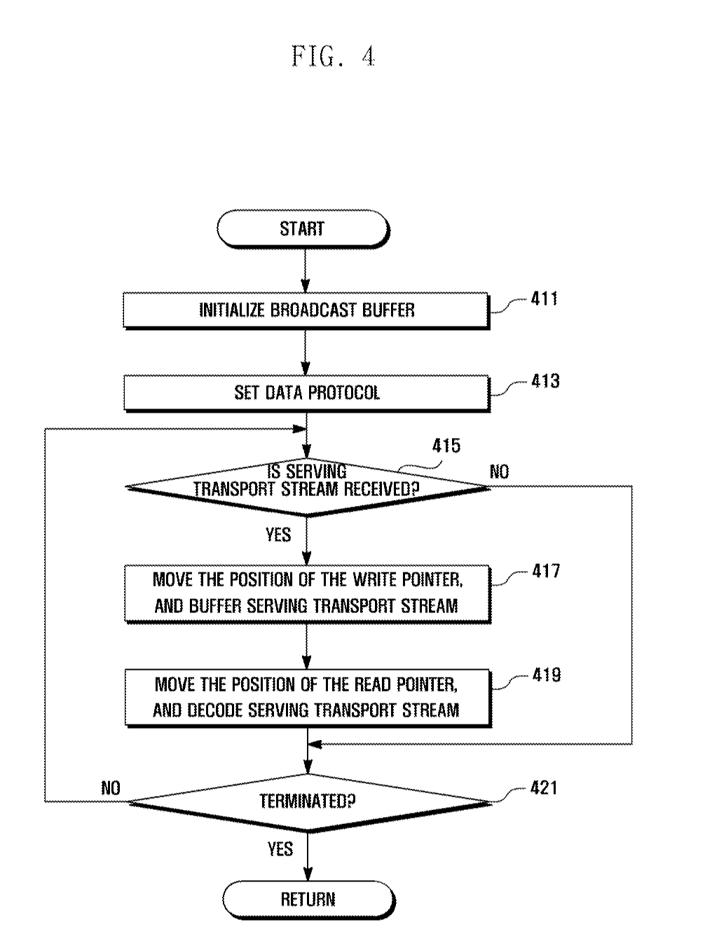

A serving broadcast channel receiving process is described below with reference to FIG. 4.

FIG. 4 is a flowchart of a serving broadcast channel receiving process according to an exemplary embodiment of the present invention.

Referring to FIG. 4, when the controller 140 enters the broadcast receiving mode, the controller 140 initializes the broadcast buffer 121 in step 411, as illustrated in FIG. 6A. That is, the controller 140 deletes remaining data from the broadcast buffer 121. The controller 140 initializes the broadcast buffer 121 so that the write pointer 611 and the read pointer 613 may point to the first address of the broadcast buffer 121. Thereafter, the controller 140 detects and sets data protocols of the serving broadcast channel via the protocol setting unit 131 in step 413. The protocol setting unit 131 may report the data protocol of the serving broadcast channel to the decoding unit 133.

When a serving TS is received via the serving broadcast channel, the controller 140 detects the serving TS in step 415, and buffers the serving TS in the broadcast buffer 121 in step 417, as illustrated in FIG. 6B. The controller 140 moves a position of the write pointer 611 along with the serving TS in the broadcast buffer 121. The controller 140 controls the decoding unit 133 to decode the serving TS in step 419. During this process, the decoding unit 133 reads the serving TS from the broadcast buffer 121, according to the position of the read pointer 613, and then decodes the serving TS. The decoding unit 133 decodes the serving TS based on the data protocol of the protocol setting unit 131. Thereafter, the controller 140 allows the read pointer 613 to indicate the position where the broadcast TS is decoded in the broadcast buffer 121.

If the controller 140 determines that the serving TS has been received in step 421, the controller 140 terminates the serving broadcast channel receiving process and returns to the procedure of FIG. 3. On the contrary, if the controller 140 determines that the serving TS has not been received in step 421, the controller 140 returns to step 415 and repeats the subsequent steps.

Referring back to FIG. 3, the controller 140 determines whether channel switching occurs from the serving broadcast channel to a target broadcast channel in step 317. When the controller 140 determines that the serving broadcast channel is switched to a target broadcast channel in step 317, the controller 140 uses a broadcasting service via the target broadcast channel in step 319, as illustrated in FIGS. 6C and 6D. The controller 140 may select a target broadcast channel according to a signal input via the key input unit 160. During this process, the controller 140 retains the enabled state of the decoding unit 133.

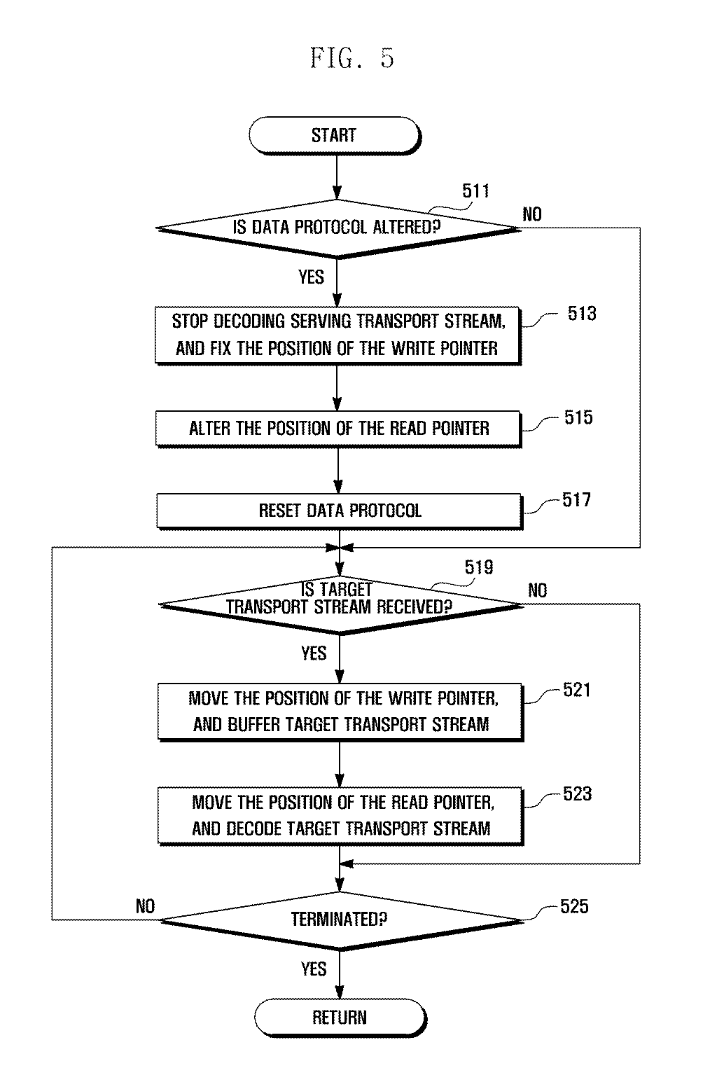

A target broadcast channel receiving process is described below with reference to FIG. 5.

FIG. 5 is a flowchart that describes a target broadcast channel receiving process according to an exemplary embodiment of the present invention.

Referring to FIG. 5, when channel switching occurs in a broadcast receiving mode, the controller 140 determines whether data protocol needs to be altered via the protocol setting unit 131 in step 511. That is, the protocol setting unit 131 compares the data protocol of the serving broadcast channel with the data protocol of the target broadcast channel.

If the controller 140 determines that the data protocol of the serving broadcast channel differs from the data protocol of the target broadcast channel in step 511, the controller 140 controls the decoding unit 133 to terminate the decoding of the serving TS in step 513, as illustrated in FIG. 6C. The controller 140 corrects the position of the write pointer 611 in the broadcast buffer 121. Thereafter, the controller 140 alters the position of the read pointer 613 in the broadcast buffer 121 in step 515. The controller 140 alters the position of the read pointer 613 to a position spaced apart from the position of the write pointer 611, with a preset pointer margin, irrespective of the current position of the read pointer 613 in the broadcast buffer 121. That is, the controller 140 reduces the preset pointer margin between the write pointer 611 and the read pointer 613 in the broadcast buffer 121. The controller 140 may delete the remaining data from the broadcast buffer 121, i.e., the serving TS. However, the controller 140 retains the write pointer 611 position and the read pointer 613 position in the broadcast buffer 121.

The controller 140 alters the data protocol in the protocol setting unit 131 in step 517. That is, the controller 140 detects and resets the data protocol of the target broadcast channel via the protocol setting unit 131. After initializing the protocol setting unit 131, the controller 140 may reset the data protocol. That is, after disabling the protocol setting unit 131 and then enabling the protocol setting unit 121, the controller 140 may delete the data protocol of the protocol setting unit 131. The protocol setting unit 131 may report the data protocol of the target broadcast channel to the decoding unit 133.

When the controller 140 determines that a target TS is received via the target broadcast channel in step 519, the controller 140 buffers the received target TS in the broadcast buffer 121 in step 521, by pointing its position via the write pointer 611, as illustrated in FIG. 6D. The controller 140 moves the position of the write pointer 611 along with the target TS in the broadcast buffer 121. The controller 140 decodes the target TS via the decoding unit 133 in step 523. The decoding unit 133 reads the target TS in the broadcast buffer 121, based on the position of the read pointer 613, and then decodes the target TS. The decoding unit 133 decodes the target TS based on the data protocol of the protocol setting unit 131. The controller 140 moves the position of the read pointer 613 to a position where the target TS is decoded, in the broadcast buffer 121.

On the contrary, if the controller 140 determines that the data protocol of the serving broadcast channel is identical to the data protocol of the target broadcast channel in step 511, the controller 140 retains the data protocol of the protocol setting unit 131 and performs steps 519 to 523 described above. During this process, the controller 140 does not need to initialize the protocol setting unit 131. That is, the controller 140 retains the enabled state of the protocol setting unit 131 and the decoding unit 133, and performs a channel switching operation.

The controller 140 determines whether the target TS has been completely received in step 525. If the controller 140 determines that the target TS has been received in step 525, the controller 140 terminates the target broadcast channel receiving process and then returns to the procedure of FIG. 3. On the contrary, if the controller 140 determines that the target TS has not been received in step 525, the controller 140 repeats steps 519 to 525.

Referring back to FIG. 3, the controller 140 determines whether the broadcast receiving mode is terminated in step 321. If the controller 140 determines that the broadcast receiving mode is terminated in step 321, the controller 140 terminates the broadcast receiving mode by disabling the protocol setting unit 131 and the decoding unit 133. On the contrary, if the controller 140 does not determine that the broadcast receiving mode is terminated in step 321, the controller 140 repeats steps 317 to 321 described above. That is, the controller 140 switches the current target broadcast channel to another target broadcast channel. In an exemplary implementation, the current target broadcast channel is a serving broadcast channel.

Although the exemplary embodiments of the present invention are implemented in such a way that the broadcast receiving apparatus uses digital broadcasting services, it should be understood that the present invention is not limited thereto. That is, the exemplary embodiments of the present invention may be implemented with broadcast receiving apparatuses that use analog broadcasting services. In analog broadcasting, since data protocols by broadcast channels are identical to each other, the broadcast receiving apparatus does not need to compare the data protocol of the serving broadcast channel with the data protocol of the target broadcast channel, and does not reset the data protocols. Therefore, the broadcast receiving apparatus may perform a channel switching operation, while retaining the data protocol. That is, the controller 140 may retain the enabled state of the decoding unit and the protocol setting unit in a broadcast receiving mode, without initialization.

As described above, the broadcast receiving apparatus according to an exemplary embodiment of the present invention can perform a channel switching operation, without initialization, in a broadcast receiving mode. That is, the broadcast receiving apparatus does not initialize the decoding unit in a broadcast receiving mode. Thereby, the time required to perform a channel switching operation is reduced. Since the broadcast receiving apparatus does not need to initialize the decoding unit, the broadcast receiving apparatus can reduce the time required to perform a channel switching operation. In addition, since the broadcast receiving apparatus does not need to display a black screen or a guide message showing that a channel is being switched, the broadcast receiving apparatus can provide user convenience.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A broadcast receiving apparatus comprising:
a broadcast buffer for buffering a received transport stream;
a decoding unit for decoding the transport stream in the broadcast buffer; and
a controller for terminating the decoding of the transport stream by retaining an enabled state of the decoding unit when a channel switching operation is performed, for moving a position of a write pointer in the broadcast buffer when the transport stream is buffered and for correcting the position of the write pointer when the decoding of the transport stream is terminated.

2. The apparatus of claim 1, wherein the controller moves the position of the read pointer to a position to decode the transport stream, and alters the position of the read pointer to be spaced apart from the position of the write pointer, with a preset pointer margin, when the decoding of the transport stream is terminated.

3. The apparatus of claim 1, further comprising:
a protocol setting unit for detecting data protocol of the transport stream, for setting the data protocol, for reporting the data protocol to the decoding unit, for determining whether the data protocol is altered when a channel switching operation is performed, and for performing an initialization if it is determined that the data protocol has been altered.

4. The apparatus of claim 3, wherein the determination of whether the data protocol is altered comprises comparing the data protocol of the serving broadcast channel with the data protocol of the target broadcast channel.

5. The apparatus of claim 3, wherein the decoding unit decodes the transport stream according to the data protocol and terminates the decoding of the transport stream if the data protocol is altered.

6. The apparatus of claim 5, wherein the controller corrects the moved position of the write pointer in the broadcast buffer if the data protocol is altered.

7. The apparatus of claim 3, wherein the initialization is performed by disabling the protocol setting unit and enabling the protocol setting unit.

8. A method for switching channels in a broadcast receiving apparatus, the method comprising:
buffering, when a serving transport stream is received via a serving broadcast channel, the received serving transport stream in a broadcast buffer, and moving a position of a write pointer along with the buffered serving transport stream;
correcting, when the serving broadcast channel is switched to a target broadcast channel, the position of the write pointer in the broadcast buffer; and
buffering, when a target transport stream is received via the target broadcast channel, the received target transport stream in the broadcast buffer, based on the corrected position of the writer pointer, and moving the position of the write pointer along with the buffered target transport stream.

9. The method of claim 8, further comprising:
altering the position of a read point to be spaced apart from the corrected position of the write point, with a preset pointer margin, in the broadcast buffer;
decoding, when the received target broadcast transport stream is buffered, the buffered target transport stream according to the altered position of the read pointer in the broadcast buffer; and
moving the altered position of the read pointer.

10. The method of claim 9, further comprising:
initializing, when a broadcast receiving mode starts, the position of the write pointer and the read pointer in the broadcast buffer;
decoding, when the received serving transport stream is buffered, the buffered serving transport stream in the broadcast buffer; and
moving the initialized position of the read pointer.

11. The method of claim 8, wherein the correcting of the position of the write pointer in the broadcast buffer comprises:
comparing data protocol of the serving broadcast channel with the data protocol of the target broadcast channel; and
correcting the moved position of the write pointer in the broadcast buffer, if the data protocol differs between the serving broadcast channel and the target broadcast channel.

12. A method for switching channels in a broadcast receiving apparatus, the method comprising:
enabling a decoding unit when a broadcast receiving mode starts;
decoding, when a serving transport stream is received via a serving broadcast channel, the received serving transport stream in the decoding unit;
terminating the decoding of the received serving transport stream in the decoding unit, when the serving broadcast channel is switched to a target broadcast channel;
decoding, when the target transport stream is received via the target broadcast channel, the received target transport stream in the decoding unit; and
disabling the decoding unit when the broadcast receiving mode is terminated.

13. The method of claim 12, further comprising:
correcting a moved position of the write pointer in the broadcast buffer when decoding of the buffered serving transport stream is terminated;
buffering, when the target transport stream is received, the received target transport stream according to the corrected position of the write pointer in the broadcast buffer; and
moving the position of the write pointer along with the buffered target transport stream.

14. The method of claim 13, further comprising:
altering the position of the read pointer to be spaced apart from the corrected position of the write pointer with a preset pointer margin in the broadcast buffer;
decoding, when the received target transport stream is buffered, the buffered target transport stream according to the altered position of the read pointer in the broadcast buffer; and
moving the altered position of the read pointer.

15. The method of claim 14, further comprising:
initializing the write pointer position and the read pointer position in the broadcast buffer when the broadcast receiving mode starts.

16. The method of claim 15, further comprising:
decoding, when the received serving transport stream is buffered, the buffered serving transport stream in the broadcast buffer; and
moving the initialized position of the read pointer.

17. The method of claim 13, wherein the moved position of the write pointer is corrected by comparing data protocol of the serving broadcast channel with the data protocol of the target broadcast channel.

18. The method of claim 17, wherein the moved position of the write pointer is corrected in the broadcast buffer, if the data protocol differs between the serving broadcast channel and the target broadcast channel.
